(19) United States
(12) Patent Application Publication
(10) Pub. No.: US 2024/0178787 A1
(43) Pub. Date: May 30, 2024

(54) SOLAR PANEL CLEANING SYSTEM

(71) Applicants: Aviel DAHAN, Karmiel (IL); Avraham TAVOR, YOKNEAM ILIT (IL); Jacob FRIEDRIECH, TIVON (IL)

(72) Inventors: Aviel DAHAN, Karmiel (IL); Avraham TAVOR, YOKNEAM ILIT (IL); Jacob FRIEDRIECH, TIVON (IL)

(21) Appl. No.: 18/521,925

(22) Filed: Nov. 28, 2023

Related U.S. Application Data
(60) Provisional application No. 63/428,123, filed on Nov. 28, 2022.

(51) Int. Cl. H02S 40/10; B08B 3/02

(52) U.S. Cl. CPC H02S 40/10; B08B 1/16; B08B 3/024

(57) ABSTRACT

A system for cleaning solar panels, the system comprising: a mobile assembly for cleaning solar panels, where the mobile assembly is movable over cover surface of the solar panels, a stationary assembly for moving the mobile assembly, where the stationary assembly is fixed relative the solar panels; a water feeding assembly for feeding water to the mobile assembly, the water feeding assembly connects to and is in fluid communication with the mobile assembly; and a control and command cabinet for controlling operation of the mobile assembly, stationary assembly and water feeding assembly, where the stationary assembly connects mechanically to the mobile assembly and is configured to travel the mobile assembly over the cover surface of the solar panels according to commands delivered from the control and command cabinet.

### TECHNICAL FIELD

The present invention pertains to cleaning solar panels. Particularly, the present invention pertains to a water-based system for washing, brushing and wiping solar panels to keep them maximally exposed to sun radiation.

### BACKGROUND

Solar panel cleaning is a major factor in the efficiency of solar panels, as the accumulation of dirt on the panel surface blocks sun radiation, thus reducing the electricity production of the panel. Solar panel manufacturers recommend frequent cleaning of the panels to maintain optimal electricity production and long-term durability of the system. Today there are various methods for cleaning solar panels, either by manual means, fixed sprinkler means or automatic means. Manual means include manual scrubbing of the panels with mechanical brush and/or water pressure, using clean water or a cleaning solution. This method provides high level of cleaning, but is an expensive method due to the use of massive manual labor, and is extremely risky when cleaning panels which are installed at high places, which is usually the case in most installations. The risks and cost of this method result in low frequency of cleaning, making it less effective in maintaining high productivity of electricity by the panels. Fixed sprinkler cleaning means include a comprehensive array of water sprinklers, which are installed around the edges of the solar panels after their construction. The sprinklers are connected via a net of water pipes, providing water pressure to the complete array of sprinklers. The sprinklers are then activated on a timely basis, creating a flood of water on the surface of the panels, causing the dirt to drift down along the natural slope of the panels. This method consumes a lot of material and labor for assembly and installation, suffers from low pressure of water due to the plurality of sprinklers that consume water, and can only create a flood of water which is not effective in breaking and removing all types of dirt. Automatic means for cleaning include various robotic systems installed on the panels, which are automatically driven along the panel array and clean the panels with a spray of water, which can be accompanied by mechanical cleaning of the panels surface. These means provide high level of cleaning, yet their disadvantages are high costs, a technically complex system for installation, maintenance, troubleshooting and repair, including sensors, motors, generators and controllers.

It is a well-known problem that sprinkler-based water cleaning methods of solar panels do not remove solid dirt, such as birds' feces, dust and mud. This is because the sprinkled water turns into a run-off down the inclined panels, which causes the solid dirt to accumulate at or near the panels lower frame. The most successful combination is sprinkling water and wiping or sweeping off that comprises frictional movement on the panels' surface. An example of an instrument for the second action is a revolving broom. A robot is an example of the combined water sprinkling and frictional movement in cleaning solar panels. However, this solution is costly and complex.

Yet another disadvantage of the sprinkler system is the fact that the dirt is accumulated at the bottom rim of the panel, which later dries and accumulates over time. This problem is solved by the means of robotic cleaners, but at a high cost of mechanical means.

It is, therefore, an object of the present invention to provide a solar panel cleaning system that provides all of the capabilities of current cleaning systems with improved and cost-effective performance.

It is yet another object of the present invention to provide a solar panel cleaning system with mechanical functionalities that solve cleaning problems such as water stains and accumulated dirt at the edges of the panel frame.

This and other objects and embodiments of the present invention will become apparent as the description proceeds.

### SUMMARY

The present invention, therefore, provides an advantageous technically more simple solution for cleaning and cleansing solar panels that combines water sprinkling at high and low pressure and frictional movement on the surface of the protecting glass of the panels. This solution is more easily installed, operated and maintained, yet provides a thorough cleaning of the solar panels, including solid and solidified dirt such as bird feces, dust and mud. Furthermore, this solution is cheaper than any one of the currently known and used devices and methods for cleaning solar panels.

In view of the above, the present invention provides a system for cleaning and cleansing solar panels that combines water sprinkling at high pressure and frictional movement on the protecting glass of solar panels and a mechanism that advances the cleaning and cleansing means along the panels. It also includes specially dedicated sprinklers for removing all residual dirt from the bottom rim of the panel to prevent any accumulation of dirt in this area.

In one particular embodiment, the present invention provides a system for cleaning solar panels, the system comprising: a mobile assembly for cleaning the solar panels, where the mobile assembly is movable over cover surface of said solar panels, a stationary assembly for moving the mobile assembly, where the stationary assembly is fixed relative the solar panels;

a water feeding assembly for feeding water to the mobile assembly, the water feeding assembly connects to and is in fluid communication with the mobile assembly; and a control and command cabinet for controlling operation of the mobile assembly, stationary assembly and water feeding assembly, where the stationary assembly connects mechanically to the mobile assembly and is configured to travel the mobile assembly over the cover surface of the solar panels according to commands delivered from the control and command cabinet.

In still another particular embodiment the mobile assembly comprises:
a rack mounted above said cover surface of the solar panels; and
jet sprinklers attached to nozzles in the rack;
where the jet sprinklers are configured to receive water from said water feeding assembly through said nozzles in said rack and spray water on cover surface of said solar panels,
where the solar panels are in inclined position, and the at least one pulley is parallel elevated side of the solar panels,
where the jet sprinklers are adjustable to different directions including up, down, left and right relative to the cover surface of said solar panels,
where slide(s) at end of inclined legs of the rack are mechanically held to a steel cable and configured to slide over the steel cable,
where the rack travels over the surface cover of the solar panels when the steel cable roles around drive wheels.

In still another particular embodiment, the stationary assembly comprises:
an electric motor;
a drive shaft;
at least one pulley comprising drive wheels at opposite ends of the at least one pulley and a steel cable stretched between and over said drive wheels;
a start sensor;
a termination sensor;
electronic cards; and
an electric circuitry.

The electric motor is mounted on the drive shaft and configured to move said drive shaft in a rotational movement.

The drive shaft mechanically connects to drive wheels of the mobile assembly and transfers the rotational movement to the drive wheels of the mobile assembly. The rotational movement of the drive wheels translates to linear movement of a steel cable stretched over and between the drive wheels.

The linear movement of the steel cable makes rack of the mobile assembly travel over cover surface of the solar panels.

The start and termination sensors are configured to identify start and termination positions of the mobile assembly and correspondingly initiate, terminate and reverse travel of said rack over said cover surface.

In still another particular embodiment, the drive shaft is telescopic and connects to the electric motor at an engagement point on one end and a drive wheel on an opposite end, where the telescopic drive shaft transfers radial movement from the electric motor to the drive wheel and is configured to extend and contract according to width of the solar panels, where the electric motor controls axial movement of the drive shaft for extending and contracting according to the width of the solar panels.

In still another particular embodiment, the water feeding assembly further comprises a high pressure water pump and water pipe for feeding water to said mobile assembly at high pressure.

In still another particular embodiment, the mobile assembly comprises a single pulley parallel an elevated side of the solar panels in inclined position, where the pulley comprises drive wheels and a steel cable stretched over and between the drive wheels; and a single or assembly of, long range, run-off, splash sprinkler attached to the steel cable with slides.

Such system comprises the following parts:
an electric motor driven system of cables and pulleys;
a rack, which is connected to the system of cables and pulleys, and carries a system of water sprinkling nozzles that covers the surface area of the panels; and
a water feeding system that receives water from a water feeding source.

Optionally, the water sprinkling nozzles/jet sprinklers are connected to a water feeding drum (reservoir) or directly to a main, local or municipal water supply system.

Optionally, the water feeding system receives water with a high pressure water pump.

In one embodiment, the system of cables and pulleys is installed on two opposite sides of the panels, specifically the upper and lower sides of inclined panels.

Usually, a 4 bar water pressure is sufficient for cleaning the solar panels.

An elevated water pressure may be considered with the addition of a pump if required to generate sufficient water pressure in the nozzles of the water sprinklers. Preferably, such water pump may provide water at a high pressure to more than one water feeding system. Preferably, it may be located halfway between any number of arrays of solar panels to distribute water at high pressure in serial or parallel modes, depending on its capacity. The system of the present invention is also economically and technically advantageous over the other known solutions in the field. It is cost effective, especially relative to its effectiveness in cleaning solar panels. It combines high pressure water sprinkling and frictional dynamic cleansing during movement over the surface of the panels protecting glass without employing manpower or using complex and expensive automatic devices. Its installation is simple and fast, even under field environments, and absolves the need for heavy machinery to travel the system over the panels such as tractors and a large cleaning device during the cleaning operation.

In one embodiment, the motor and driving system is stationary and does not move with the moving parts of the system. This protects its parts from undesirable vibrations that harm their operation and enables to shield them from exposure to changing weather conditions such as the sun, winds and rain. This is unlike the robot that travels along the solar panels with all its parts and subsystems.

In still another embodiment, the system does not need a water supply system to be deployed over the entire roof or field of panels but a single point of distribution.

In still another embodiment, the system is modular and can be adapted, expanded or reduced in proportion to the dimensions of the solar panels, namely width and length.

In still another embodiment, the system efficiently cleanse solar panels regardless of the accuracy, alignment and leveling of their installation. It can travel along arrays of solar panels that are not accurately leveled or aligned relative each other.

In still another embodiment, selected nozzles on the rack of water sprinklers, which is attached to and travels along the solar panel(s), are dedicated to expel solid or solidified dirt, dirt and dirt traces out and away from the lower end of the panel(s) during traveling of the rack. Such nozzles may be located along the rack and particularly at its edges.

In still another embodiment, the system comprises dedicated high water pressure sprinklers, namely jet sprinklers, for the upper end of the solar panels, to remove and wash off solidified dirt that adheres to the panel's protecting glass, such as dried out mud and birds' feces. In still another embodiment, the nozzles are adjustable in three dimensions relative to the axis of the rail over which the rack travels, a distance ahead of the rack and angularly relative to the rack as a reference line. The addition of splash sprinklers for throwing water at large distances ahead of the rack is advantageous in wetting any solid or solidified dirt before the water that is streamed out of the water jet sprinklers reaches it. This enables to more easily remove it with the water jet sprinklers, namely with high water pressure sprinklers or different types of wipers and sweepers. Accordingly, in one embodiment, the system of the present invention comprises two sets of sprinklers: long range sprinklers, termed splash sprinklers, that create run-off stream of water down the slope of the inclined panels and intended to wet and/or dissolve hard dirt and water jet sprinklers that clear the wetted or dissolved dirt off. Optionally, the rack of the system further comprises wipers and sweepers that create frictional contact with the surface of the protecting glass of the panels and cleanse or expel solid dirt or dirt or water stains.

In still another embodiment, the system of the present invention comprises backwards sprinklers relative to the direction of movement of the rack in addition to the forward sprinklers. Such backwards sprinklers may be configured to remove dirt residues that are left behind because the water run-off, long distance sprinklers has not wetted them enough, and/or the jet sprinklers has not applied sufficient force to remove them, and/or the wiping and sweeping devices have dragged them along with the rack.

In still another embodiment, the system of the present invention activates dedicated sprinklers during its drive back to a base position, in order to remove any residual dirt from the panel.

The following illustrates schematics and principles of the system of the present invention without limiting its scope or departing from its general concept.

### BRIEF DESCRIPTION OF THE DRAWINGS

FIG. 1 is a schematic illustration of the system of the present invention.

FIG. 2 is a schematic illustration of a central control system for a plurality of cleaning system, which are mounted on a farm of solar panels that comprises multiple panel arrays.

FIG. 3 visualizes a closer three dimensional view of the system of the present invention.

FIG. 4 exemplifies different directions of water sprinkling relative to the solar panel surface with adjustable nozzles.

FIG. 5 visualizes the fixed non-moving parts of the system.

FIG. 6 illustrates the types of nozzles used at the middle and edges of the rack and special nozzles for sweeping and wiping along the width of the solar panels.

FIG. 7 illustrates an optional configuration of the system of a traveling run-off single or assembly of sprinklers that travel along the steel cables of the pulley at the upper end of an inclined array of solar panels.

FIG. 8 illustrates the combined operation of jet sprinklers and special side cleaning devices and/or sprinklers that clean the margins of the solar panels.

FIG. 9 is a close-up view of the rack and means for traveling on the solar panel surface.

FIG. 10 is a particular configuration of a single panel adapted cleaning system with a single upper pulley and a triangular travelling rack

FIG. 11 illustrates the stationary assembly that drives the moving assembly of the system with the electric motor.

FIG. 12 shows a zoom-in view of the stationary assembly of the system that comprises the cable stretchers at the sides of the drive shaft.

FIG. 13 illustrates a cable organizer which is mounted on the cable of the pulleys.

FIGS. 14-15 are closer views of the cable organizer.

FIG. 16 illustrates the telescopic drive shaft of the stationary assembly of the system.

FIG. 17 illustrates the adjustable broom mounted on the rack that travels along the solar panels in the cleaning process.

FIG. 18 illustrates another option of the telescopic drive shaft that can be adjusted to the solar panels width on both sides.

FIG. 19 shows a closer view of the adjustable double broom panels with a rotary drive handle that connects to the telescopic rack and the broom nearest to the rack.

FIGS. 20-23 illustrate particular details of the start and termination sensors of the system for cleaning solar panels.

FIGS. 24-33 illustrate a particular embodiment of the traveling, run-off, assembly of, splash sprinklers.

### DETAILED DESCRIPTION OF THE DRAWINGS

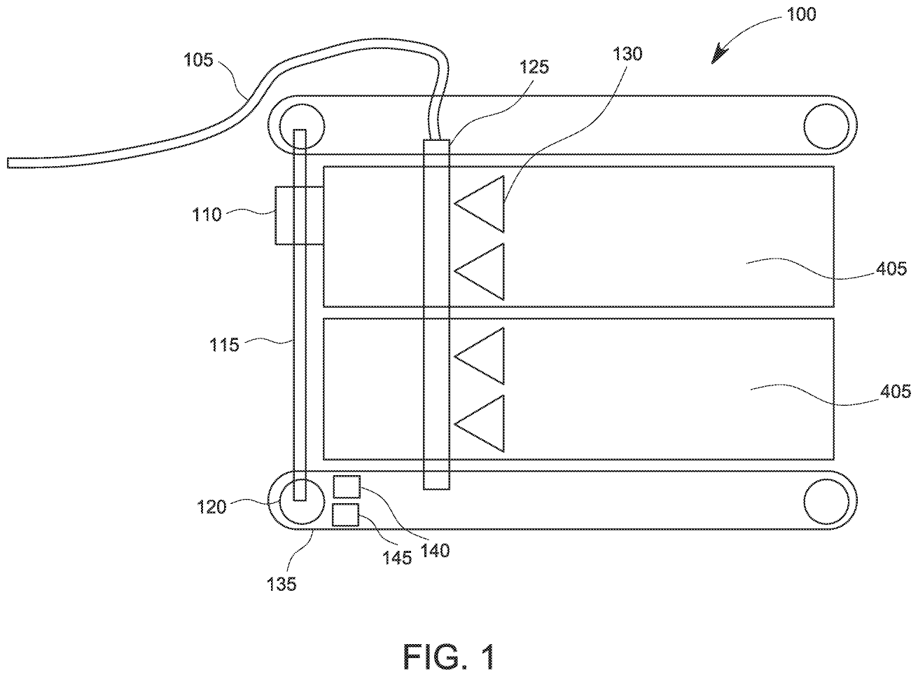

FIG. 1 is a schematic illustration of a solar panel water cleaning system 100 of the present invention. The main parts of the system 100 comprise an electric motor 110 for a drive shaft 115 that drives the drive shaft 115. The electric motor 115 is mounted on the frame of the solar panel 405 or a steel base that is fixed to the ground or floor. The drive shaft 115 is mounted on drive wheels 120 on its sides. Every pair of drive wheels 120 turns a horizontal pulley that comprises proximal and distal wheels and closed loop steel cable 135 that is stretched over them in parallel to the length of the solar panel or array of solar panels 405. A cleansing rack 125 is connected to the steel cable 135 ahead of the drive shaft 115 and a certain height in a bridge shape above the surface of the solar panels 405. The close loop movement of the steel cables 135 travels the rack 125 forwards and backwards along the length of the solar panels 405. A set of sprinklers 130 is attached to the cleansing rack 125 and fed by a water feeding pipe 105 that delivers the water from a water source through the water feeding pipe to the jet sprinklers 130. Sensors 140, 145, at the starting point near the drive shaft 115 and drive wheels 120 are configured to sense the start and finish of a traveling session of the cleansing rack 125 over and along the solar panels 405.

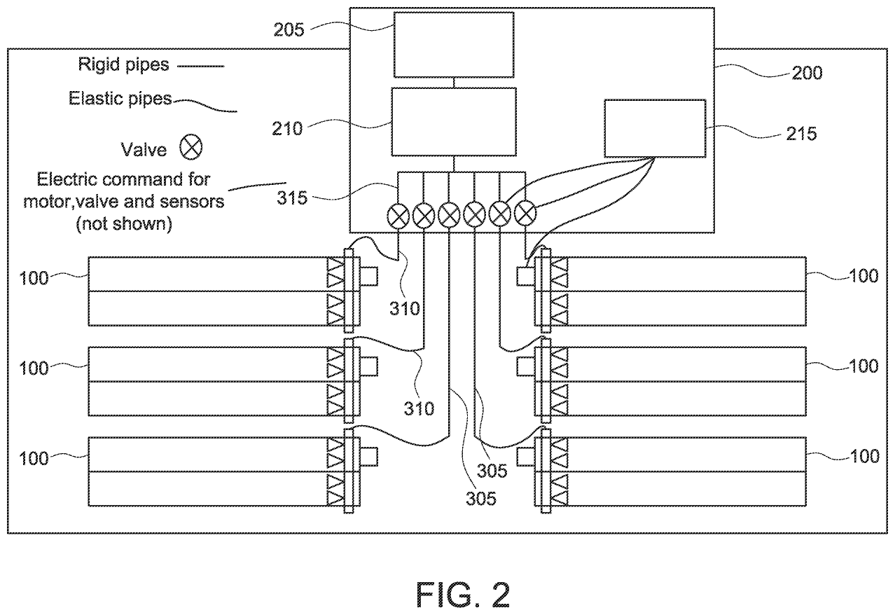

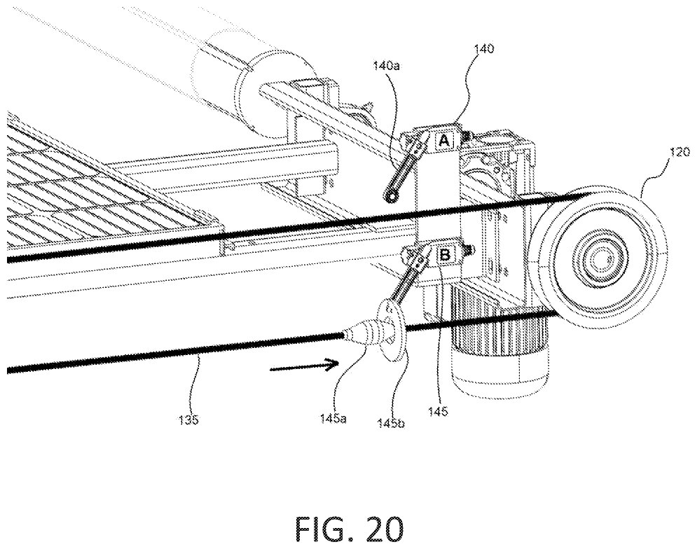

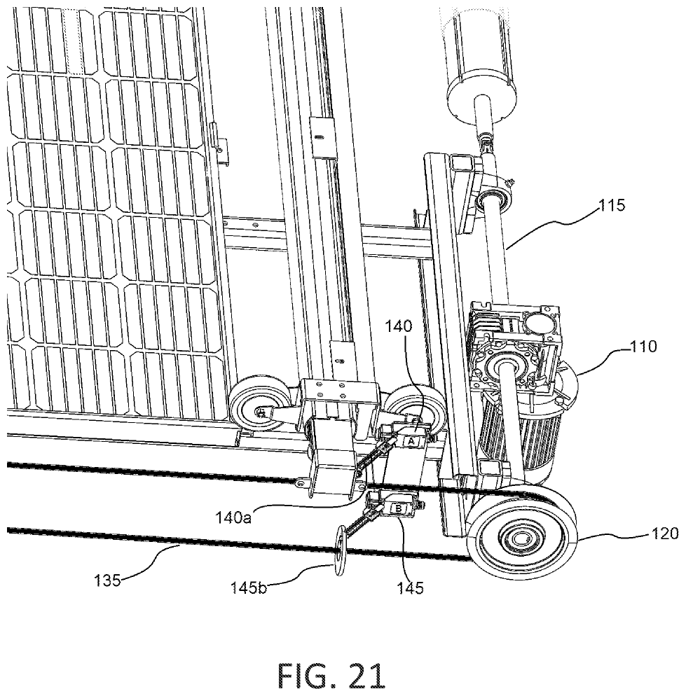

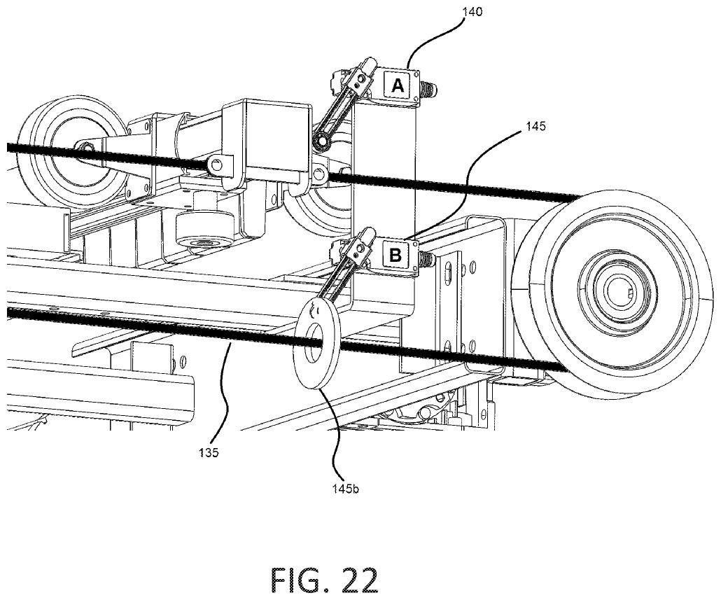

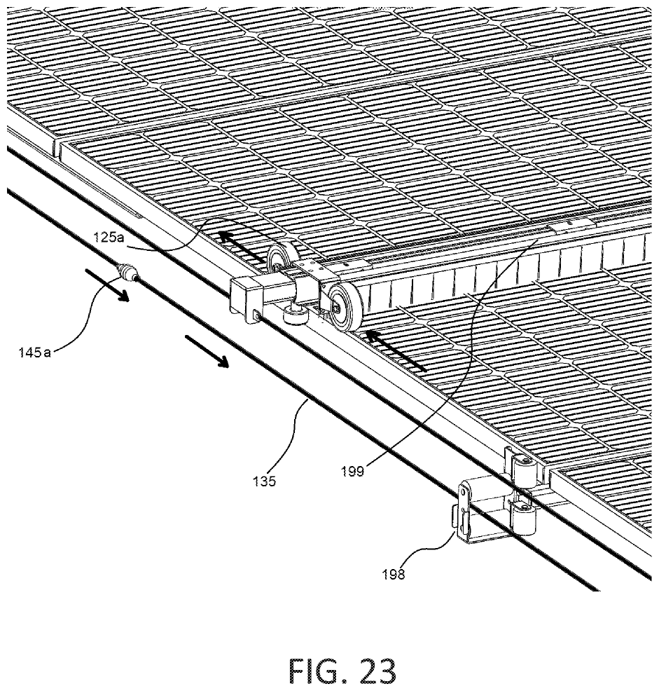

The stationary assembly that includes the electric motor 110, drive shaft 115 and pulleys, i.e., drive wheel 120 and steel cable 135, is programmed to set the mobile assembly in forward and backward motion over the solar panels according to signals that it receives from start and termination sensors, 140 and 145, respectively. The mobile assembly includes the cleansing rack 125 that carries the sprinklers 130, 180, or sprinkler carrier 105b that carries run-off traveling, run-off, long range, splash sprinkler 195. Particularly, the micro-switch of the start sensor 140 is set on when the sensor's lever 140a is pushed back against the head of the sprinkler rack 125, signaling that the mobile assembly has reached its docking point. FIGS. 20-22 illustrate this mechanism. Further, the termination sensor 145 may be located at the distal end of the solar panels to signal that the rack 125 has reached the far edge of the panels. In such configuration, it would then need to be connected to power with electric cables stretched from the electric motor of the stationary assembly or mains at the proximal edge of the solar panels. Therefore, in a more efficient configuration, the termination sensor 145 is fixed at the proximal edge of the solar panels and operates in the way illustrated in FIGS. 20-23. A fixed stopper ring 145b is in friction communication with the lever of the termination sensor 145 and mounted around the lower part of the steel cable 135. A travelling stopper ball 145a is attached also to the lower part of the steel cable 135, and positioned parallel to the distal edge of the solar panels and opposite the position of the stopper ring 145b and termination sensor 145 at the proximal edge of the panels, near the stationary assembly. When the mobile assembly, namely steel cable 135 and sprinkler rack 125 or sprinkler carrier 105b travel forwards the stopper ball 145a travels backwards. When the mobile assembly reaches the termination point at the distal edge of the solar panel, the stopper ball 145a hits the fixed stopper ring 145b and makes the lever of the termination sensor be pushed back. Then the micro-switch of the termination sensor 145 signals the stationary assembly on the arrival of the mobile assembly to the distal edge of the solar panels. The programming of the system may then command the stationary assembly to reverse the travelling of the mobile assembly back to its docking point. Then the stopper ball 145a may travel back on the lower part of the steel cable to its original point parallel the distal edge of the solar panels. This arrangement is particularly preferred over placing the termination sensor at the distal edge of a large array of solar panels. In another embodiment, the system may be set to wash and cleanse only part of the array of solar panels. Correspondingly, the mobile assembly travels to any point set between the proximal and distal edges of the solar panels. This is done by mounting the stopper ball 145a at a selected location on the steel cable 135 to which the mobile assembly should reach and put to a halt. In this arrangement, the stopper ball 145a travels back to the stopper ring 145b, when the mobile assembly travels forwards. When the stopper ball 145a reaches the stopper ring 145b and presses against it, the mobile assembly reaches its preset destination, which is the starting point of the stopper ball 145a. This arrangement is essentially not different from the arrangement of the system for full length traveling of the mobile assembly. The only difference between them is the treatment of part or all the array of solar panels. FIG. 2 is a schematic illustration of a central control system 200 for a plurality of solar panel water cleaning systems 100, which are mounted on a farm of solar panels that comprises multiple panel arrays. The control system 200 comprises a water filter and/or ion exchanger 205 for replacing calcinated compounds with compounds that do not precipitate in the water in order to prevent watermarks after washing. An optionally added water pressure pump 210 controls the distribution of water from the municipal, local or any other water supply system to the water cleaning systems through a plurality of control valves 315. Rigid pipes 305 connected to elastic pipes 310 deliver the water from the valves 315 to the cleansing rack 125 and nozzles of the jet sprinklers 130. A main electric controller 215 controls the operation of the electric motor, valves and sensors that sense the start and finish of a traveling session of the cleansing racks 125 along and above the solar panels 405.

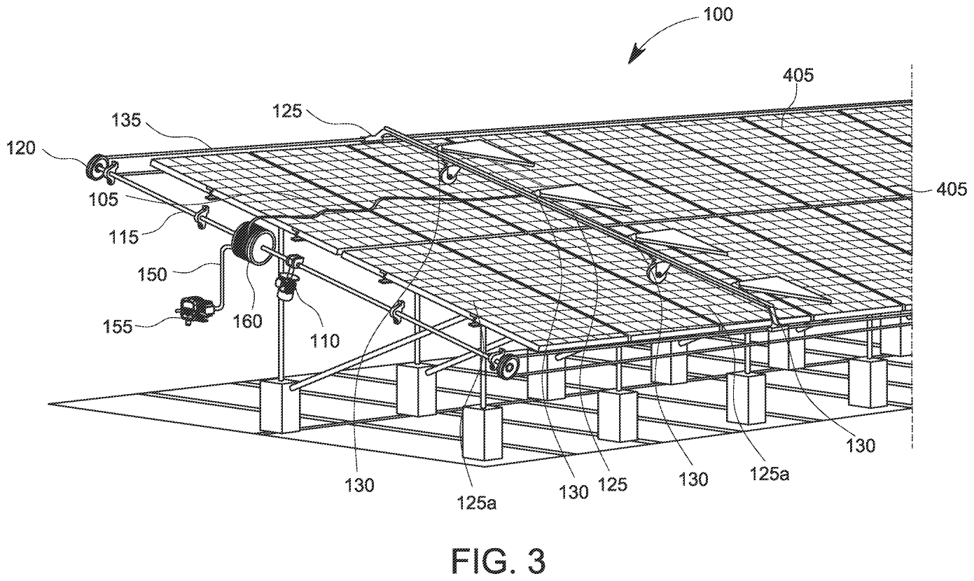

FIG. 3 visualizes a closer three dimensional view of the solar panel cleaning system 100 of the present invention. A flexible water feeding pipe 105 is wrapped over a cable drum 160 and released according to the distance of traveling of the cleansing rack 125 away from the drive shaft 115. The electric motor 110 revolves the drive shaft 115, which revolves the drive wheels 120 of the pulleys at its ends and causing the steel cable 135 to move over the proximal and distal wheels on both its ends in a radial closed loop. The cleansing rack 125, which is attached to the steel cables 135 on both sides, moves according to the direction and speed of movement of the steel cables 135. An optional water pump 155 mediates between the water feeding pipe 105 and the main water supply system and regulates the water pressure in the water feeding pipe 105 and eventually the water in the run-off, splash 180 and jet sprinklers 130.

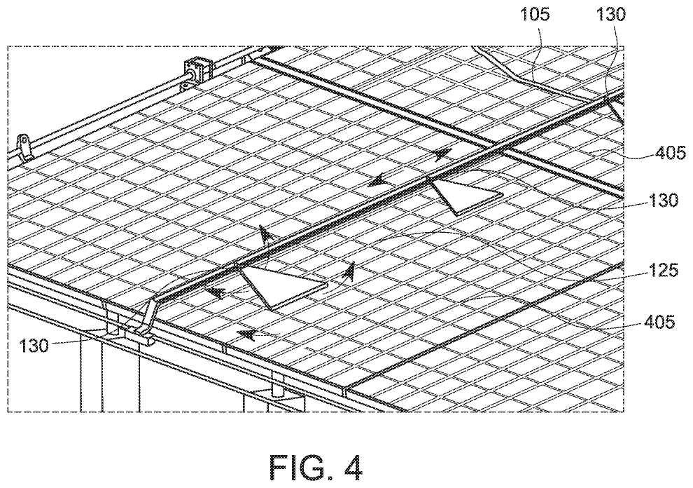

FIG. 4 exemplifies different directions of water sprinkling relative to the solar panel surface 405 with adjustable nozzles (jet sprinklers) 130. The nozzles 130 can throw water at an angle to the sides relative to the direction of movement of the cleansing rack 125, opposite the direction of movement and above and below the cleansing rack 125 and to the sides parallel to the rack 125. The simple formation of the nozzles 130 is a rake formation, in which all the nozzles 130 are directed ahead of the rack and form a water rake that forms a water front that washes the glass surface of the solar panels 400 as it advances forwards. The adjustable nozzles 130 may be turned also sideways or at an angle relative to the rack 130 to create a dynamic sweeping action, expel stubborn solid stains and marks and drive dirt off, which is accumulated at corners, edges or frame edges of the solar panels 405. The adjustment of the nozzles 130 may be permanent and fixed before start and throughout a cleaning session or dynamic and remotely controlled during the session.

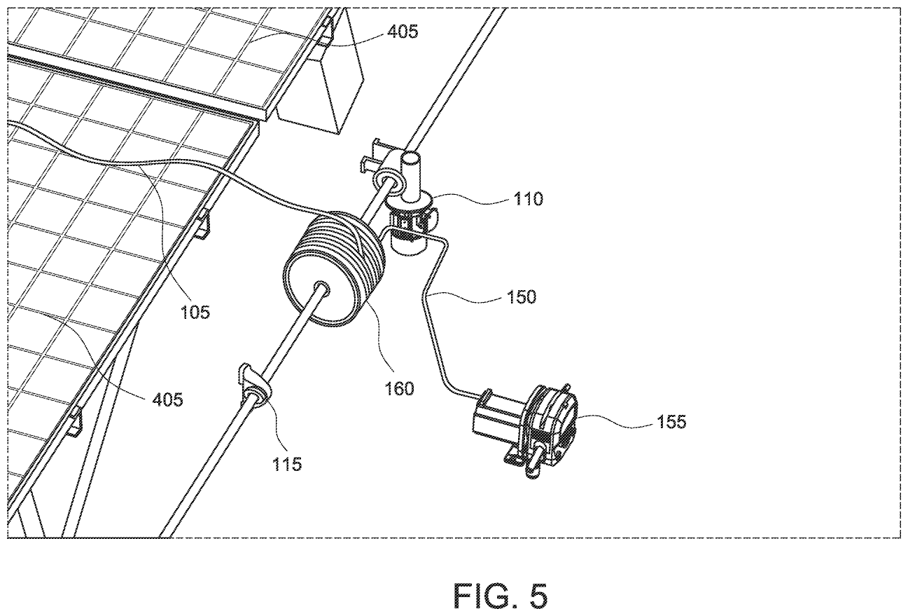

FIG. 5 visualizes the fixed non-moving parts of the system 100. These parts include the drive shaft 115 and gear turning motor 110 for rotationally turning the pulleys and cables, optionally a water pipe drum 160 for wrapping and releasing the water pipe 105 with the forward and backward movement of the rack and optionally a water pressure pump 155 with water pressure pipe 150 for increasing water pressure, when the pressure is insufficient in the main water supply system.

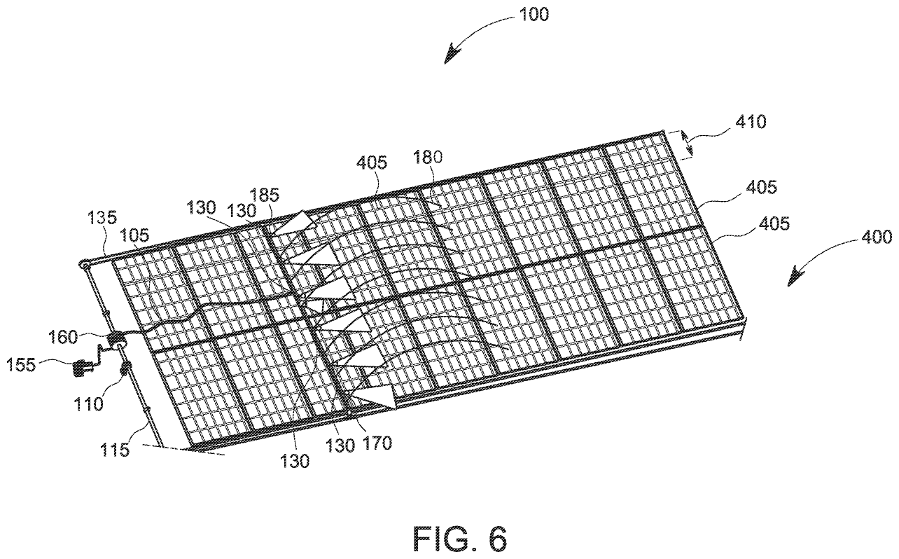

FIG. 6 illustrates the types of nozzles used at the middle and edges of the cleansing rack and special nozzles/sprinklers 130, 170, 180, 185 for sweeping and wiping along the width of the solar panels. In this particular configuration, the middle nozzles 130 are fixed and create a water rake with a forward advancing water front. Long range splash sprinklers 180 throw water ahead of the jet sprinklers 130 and other cleaning means, e.g. sweepers, wipers, and create a water pool that dissolves hard dirt and makes it easier to remove off of the solar panel surface 405. Particularly, run-off, long range, splash sprinklers 180 are configured to dissolve hard dirt or stains before arrival of said jet sprinklers. The edge nozzles/sprinklers 170, 185 are adjusted to expel solid or solidified dirt that usually accumulates there above and away from the frame of the panels. Particularly, side sprinkler 170 is fit and oriented to clean the edges of the solar panel, and “bird” wiper 185 is designed and oriented to remove solidified dry dirt off the panel edges. The adjustable sweepers and wipers may be located anywhere along the rack to pick dirt residues and cleanse the protecting glass of the panel from dirt stains and possible watermarks.

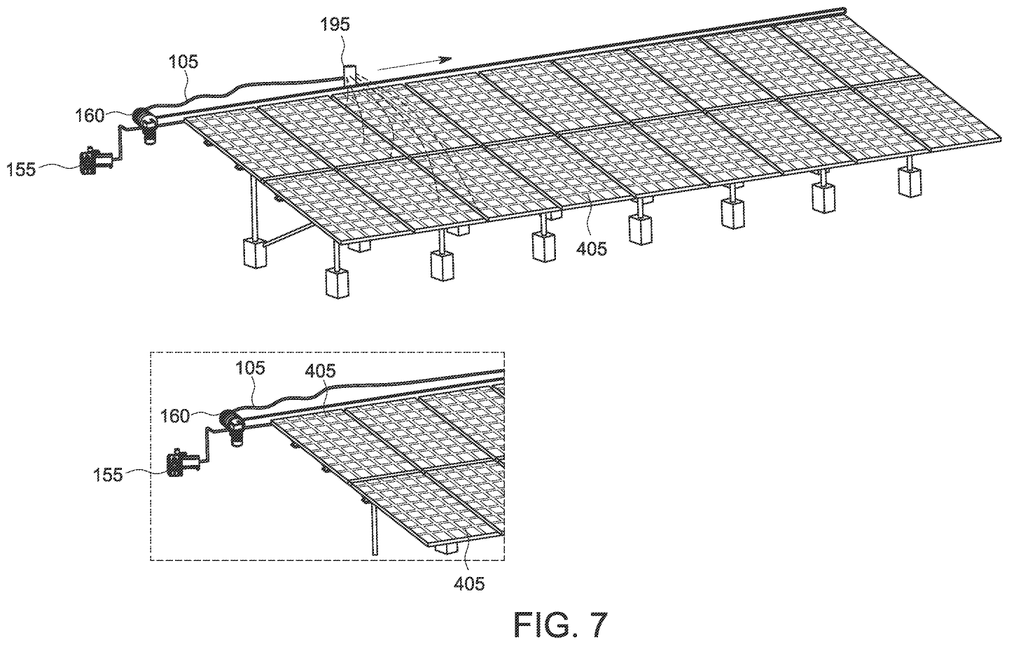

FIG. 7 illustrates an optional configuration of the system of a traveling, run-off, single or assembly of splash sprinklers 195 that travels along the steel cables 135 of the pulley at the upper end of an inclined array of solar panels 405. This configuration substitutes the traveling cleansing rack 125 of run-off (long range, splash) sprinklers, which is shown in FIGS. 1, 3, 4, and 6, and the jet sprinklers rack above the surface of the solar panels. This configuration also covers all the panels without mounting a separate cleaning system for every array.

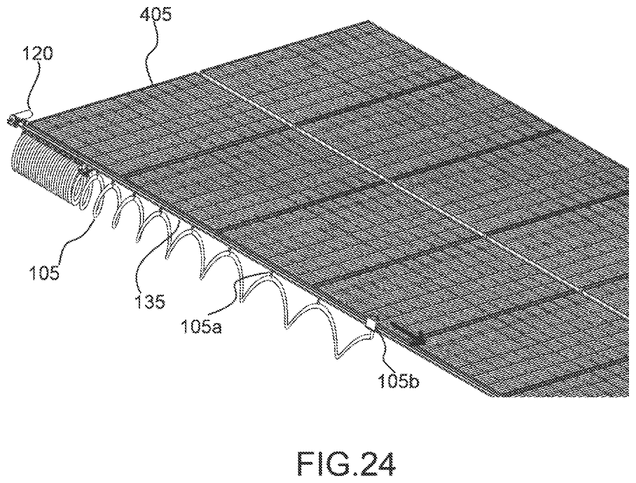

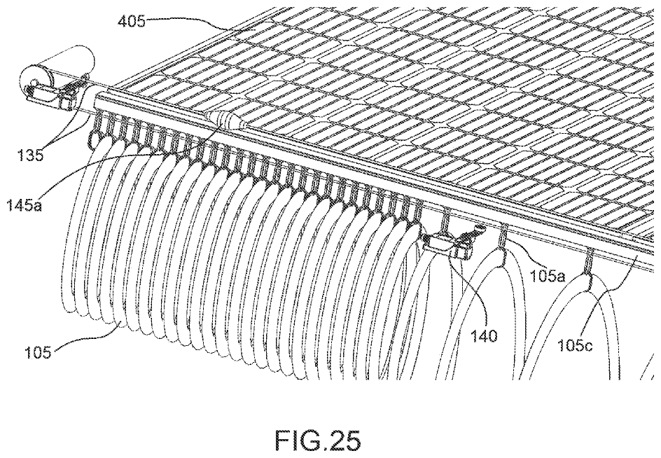

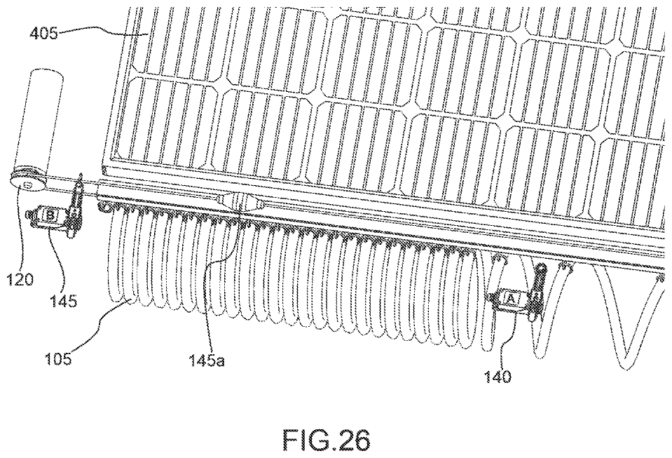

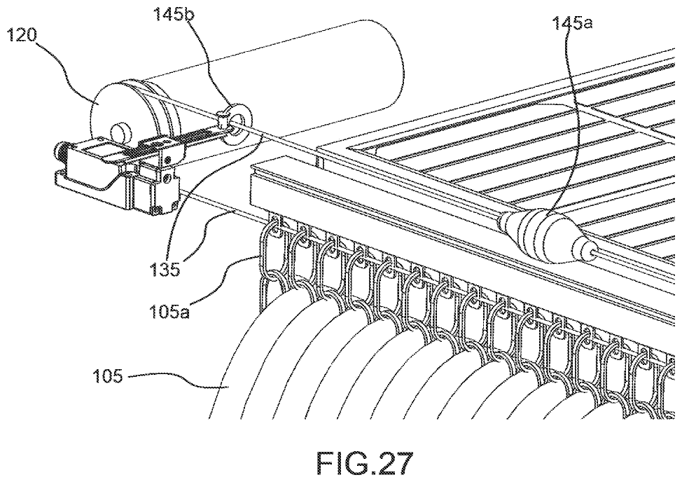

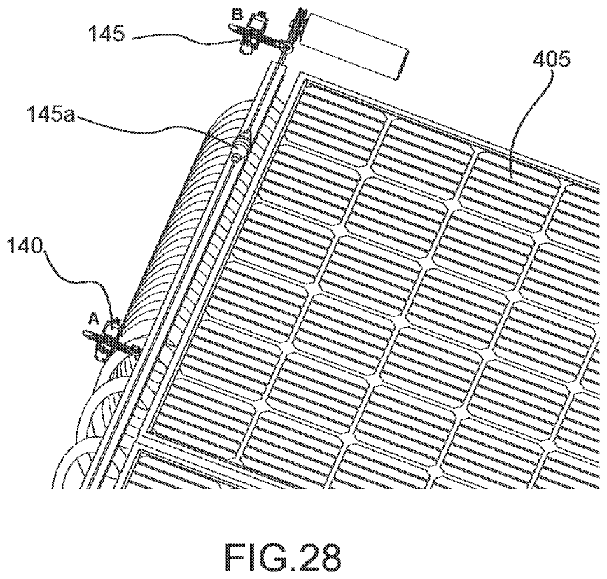

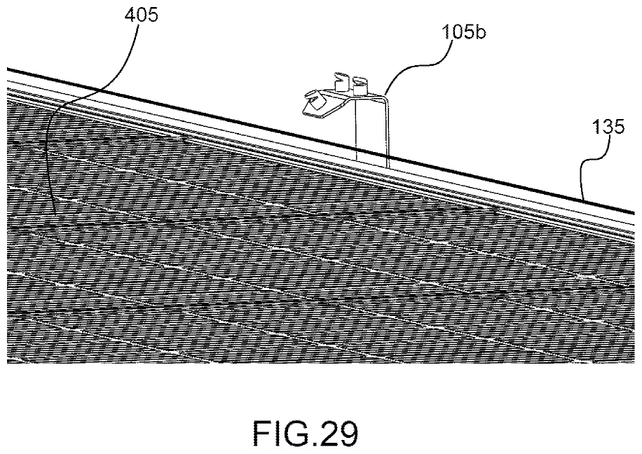

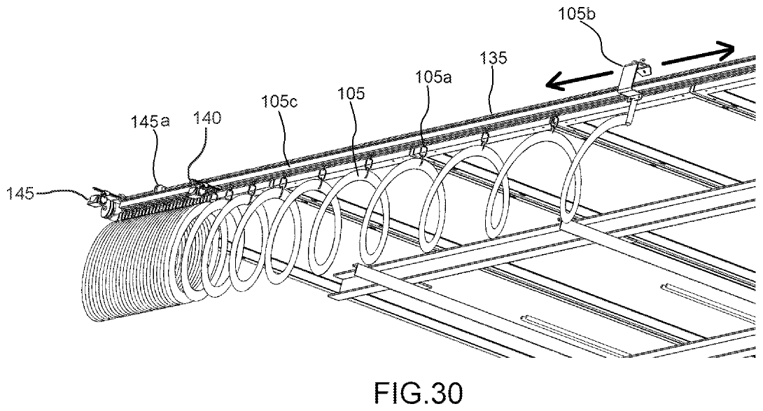

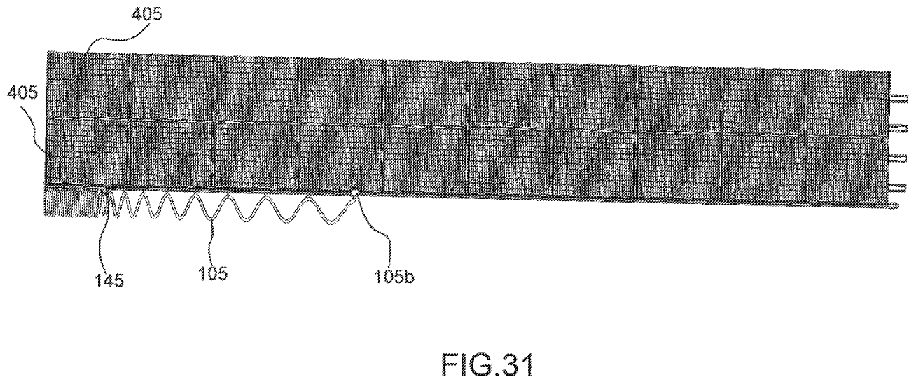

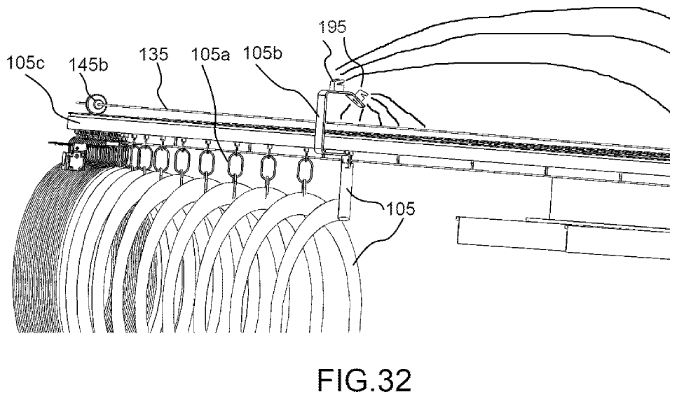

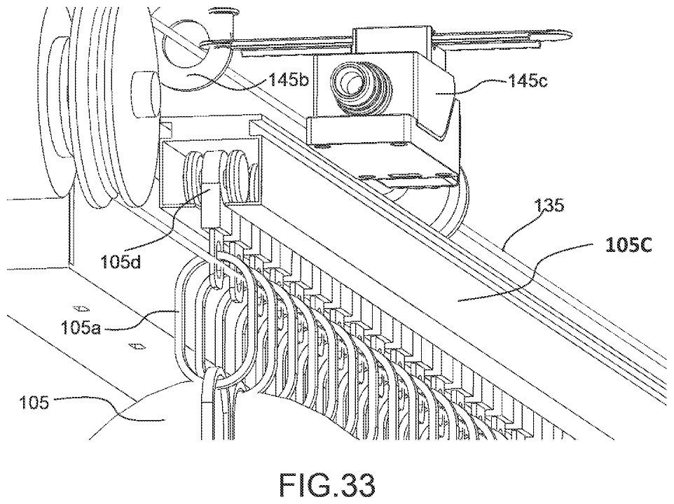

FIGS. 24-33 illustrate a variation of this configuration of a traveling, run-off, single or an assembly of, splash sprinkler 195. A deployable rack assembly is another option for deploying the water feeding pipe 105. In particular, the rack assembly comprises a rail mechanism that comprises a series of hooks 105a on which the water pipe 105 is rolled and hangs from, a parallel series of rolling wheels 105d and a rail 105c on which the wheels 105d travel. The distal end of the water feeding pipe 105 is attached to a sprinkler carrier 105b that carries the travelling, single or assembly of, splash sprinklers 195. In this configuration, as the mobile assembly travels over the solar panels, the sprinkler carrier 105b travels forwards and carries the sprinkler 195 with it. The hooks 105a drag behind the sprinkler carrier 105b that leads them forwards as the wheels 105d attached to them roll inside the rail 105c. This motion gradually deploys the water feeding pipe 105 to the length required to extend the pipe and deliver water for cleansing any certain section of the solar panels. The traveling mechanism of the termination sensor 145 may also be applied here, so that stopper ball 145a travels backwards on the upper part of the steel cable 135. Deploying the water feeding pipe 105 stops, when the stopper ball 145a hits the stopper ring 145b that is fixed near the termination sensor 145 and in friction communication with the lever of the termination sensor 145 at the proximal edge of the solar panels. In this configuration, start sensor 140 is fixed a certain distance ahead of the termination sensor 145. This distance is determined according to the folded length that the water feeding pipe 105 occupies in its folded state. For the cleansing rack 125 configuration of the mobile assembly, the start and termination sensors, 140, 145, respectively, are placed in parallel formation relative each other. See FIG. 20, for example. The same sensors are located in series formation for the run-off, traveling, single or assembly of, splash sprinklers 195. Further, the length of the folded water feeding pipe 105 actually determines also the position of the stopper ball 145a to hit the stopper ring 145b when traveling back in order to activate the termination sensor and signal the arrival of the traveling sprinkler 195 to its destination. In fact, the position of the stopper ball 145b is determined according to two variables: the preset distance determined for the water feeding pipe 105 and sprinklers to reach and the length that the water feeding pipe occupies along the length of the steel cable 135. Accordingly, the start and termination sensors 140, 145, are positioned parallel each other for the cleansing rack 125 configuration, because the water feeding pipe 105 spreads from a drum 160, which does not occupy a length along the steel cable 135 of the pulleys. For the configuration of a traveling, single or assembly of, splash sprinklers with a hanging, deployable water feeding pipe 105, the start sensor 140 cannot be located in parallel to the termination sensor 145 because of the length that the pipe 135 occupies.

In all configurations of the system 100, a threshold condition for the reverse traveling of is when the stopper ball 145a hits the stopper ring 145b and presses against the lever of the termination sensor 145. The operator is then free to determine any time delay for the traveling back.

This traveling single/assembly of sprinklers configuration of the present invention provides a more efficient, energy saving, less mechanically complicated and cost-effective alternative. This traveling single/assembly of sprinklers configuration is a far better improvement relative to current modes of static cleansing sprinklers. In the latter, a plurality of sprinklers is fixed in position in a row along the upper edge of the solar panels to cover the panels area. Installing position-fixed sprinklers along large solar panel arrays increases costs and labor, are time consuming, pose a limited capacity in installing them, and have technical difficulties. The single/assembly of, traveling sprinklers of the present invention significantly reduces cost and labor, practically eliminates the technical problems in the current method and allows installing a much larger number of arrays in any period of time.

Further advantages are that the single/assembly of, traveling sprinklers of the present invention does not need a complex deployment of water feeding pipes. A plurality of static sprinklers also requires splitting small tubes that stream water to every sprinkler, large labor and manpower, high cost of installation and only a limited workload that can be handled. Instead, only a single water feeding pipe is required in the present invention and the installation of the entire assembly is simple, fast and easy with a few nuts and two ready to install assemblies, thereby enabling higher volume of workload in significantly less time, labor and investment of money. From a volumetric throughput, the single/assembly of, traveling sprinklers reduces by orders of magnitude relative to hundreds of position-fixed sprinklers. This also eliminates the need to use a water tank or reservoir to be simultaneously available to the hundreds or sprinklers in the prior art. In turn, this requires an electric pump to stream the water from the tank to the sprinklers. Additionally, this tank loads a heavy weight up to hundreds of kilograms that cannot be mounted on rooftops of buildings, particularly light weight roofs with minimal support. Such tanks should then be placed on the ground, which complicates installation and the apparatus for feeding water to the sprinklers on the rooftops. The single, traveling sprinkler only requires minimal pressure and throughput, which is similar to that in a household faucet.

Another problem entailed with high throughput of water is the need to filter it with powerful, large filters to prevent accumulation of scale on the cover surface of the solar panels. Accumulation of scale increase opacity and reduces efficiency of the solar panels. The single/assembly of, traveling sprinklers eliminates this problem too, because of the low throughput. As a result, the only minimal filters are required.

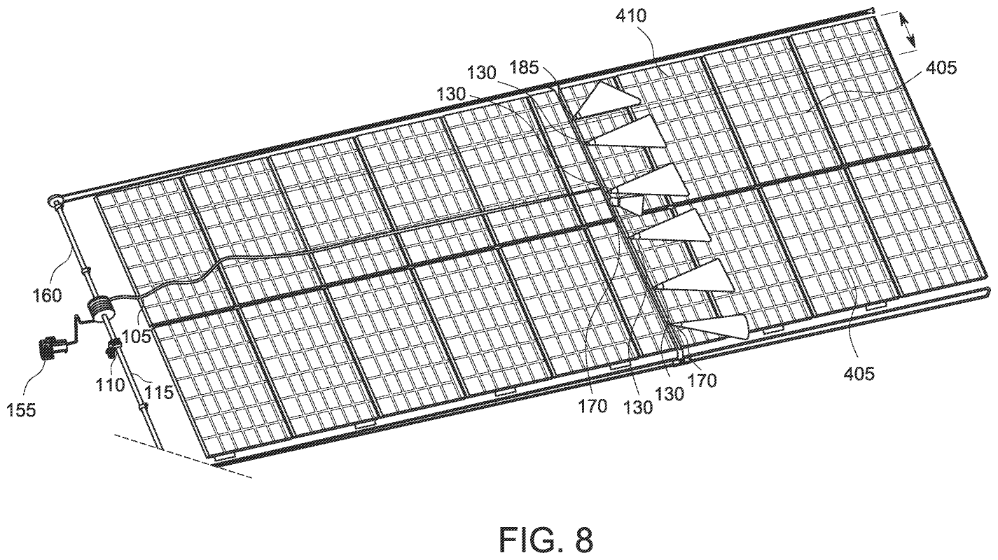

FIG. 8 illustrates the combined operation of long range run-off, splash sprinklers (not shown in this Figure. See FIG. 6) ahead of jet sprinklers 130 and direction of travel of the rack 125. Run-off sprinklers splash water ahead of the water front of the water rake, which is formed by the jet sprinklers in the middle of the rack. Solid dirt is soaked with water before the water front reaches it, which makes it easier for the jet sprinklers to wash it off. Adjustable edge sprinklers, 170, 185, remove solid or solidified dirt from the edges of the panels near the panels' frame. Sweeping and wiping sprinklers or other devices sweep solid residues off, wipe stains and clear watermarks off of the protecting glass of the solar panels.

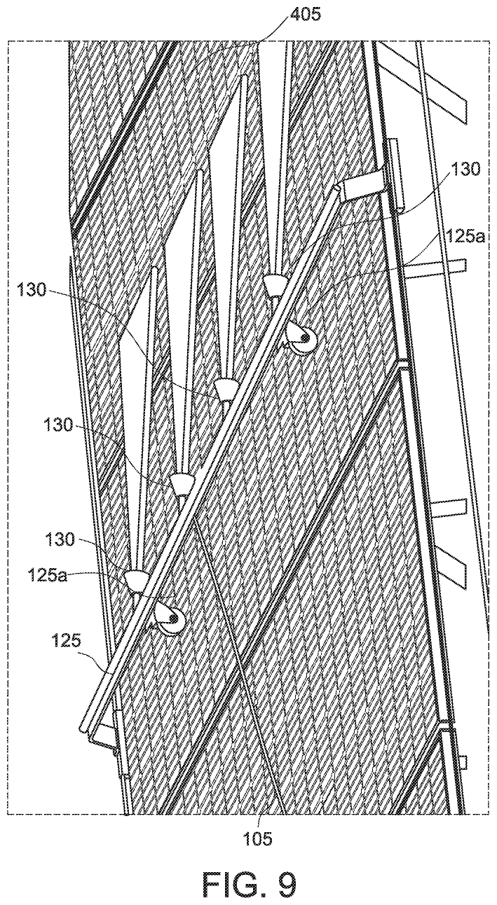

FIG. 9 is a close-up view of the rack 125 and means for traveling on the solar panel surface, wheels 125a that enable the rack to travel on the panel surface 405 and rails at the edges of the panels. The rack 125 is shaped as an elevated bridge above the surface of the solar panels with slides that attach to the panel frame or steel cables at its ends and hinged wheels 125a at its middle that travel over the panels' surface forward and backwards.

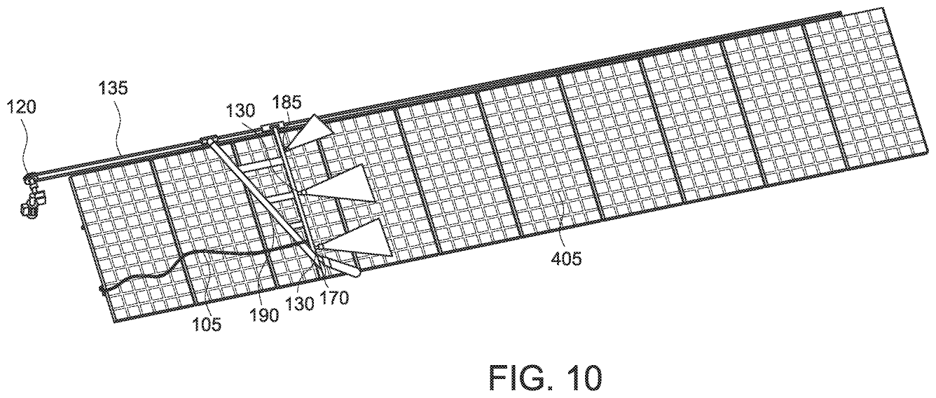

FIG. 10 is a particular configuration of a single panel adapted cleaning system with a single upper pulley, 120 and steel cable 135, and a triangular travelling rack 190. The base of the triangular rack is attached to the steel cable of the upper pulley of an inclined solar panel or array of solar panels, and its apex rolls over the solar panels with a wheel attached to it. The attaching of the triangular rack is done with slides that slide along the steel cable on one end and the wheel on the other end. The rack may carry long range, run-off, splash (not shown in this Figure. See FIG. 6) and jet water sprinklers 125 and sweepers and wipers, 170, 185 that may be floor rags, brushes, combs and brooms, which are optionally wetted or combined with water nozzles. This configuration is effective for an array of single solar panels that does not need a stationary assembly for driving the rack over the cover surface of the panels.

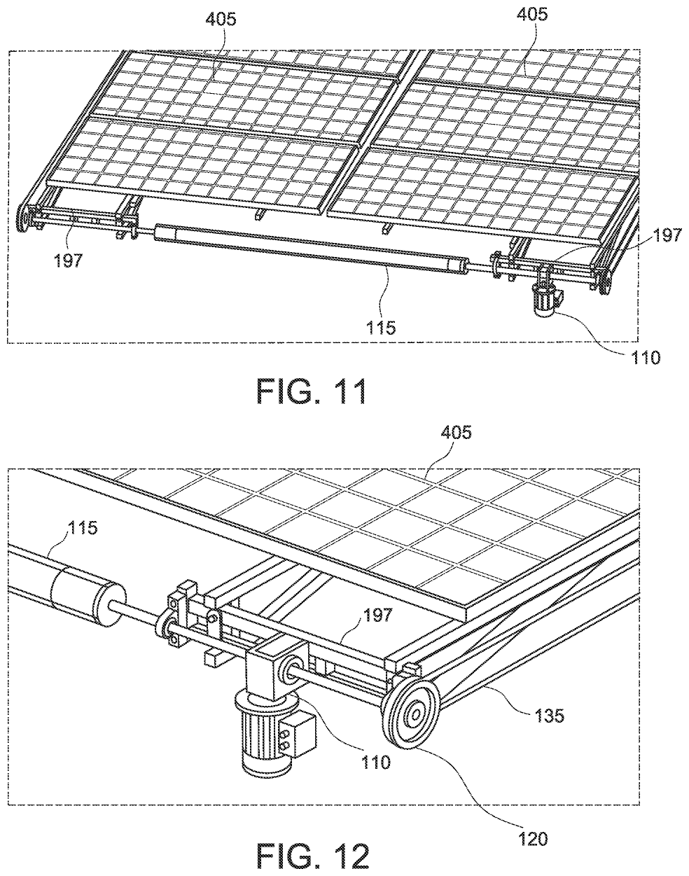

FIG. 11 illustrates the stationary assembly that drives the moving assembly of the system with the electric motor 110 that connects to the drive shaft 115 that connects to the pulleys including the drive wheels 120 cables 135 (see FIG. 12, for example) and cable stretchers 197 at the sides of the array of solar panels.

FIG. 12 shows a zoom-in view of the stationary assembly of the system that comprises the cable stretchers 197 at the sides of the drive shaft 115. These stretchers keep the cables 135 at the lower and upper sides of the array of panels tight so that the rack of the moving assembly can slide along and over the solar panels.

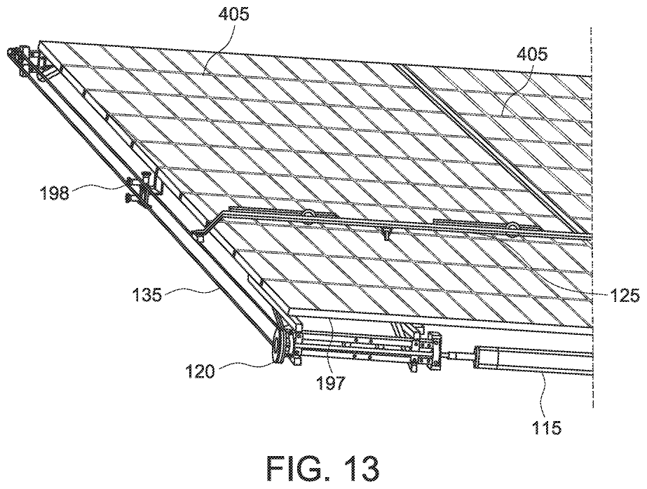

FIG. 13 illustrates a cable organizer 198, which is mounted on the cable 135 of the pulleys 120 and keeps the forward and backward moving sections of the cable in place without getting entangled with each other.

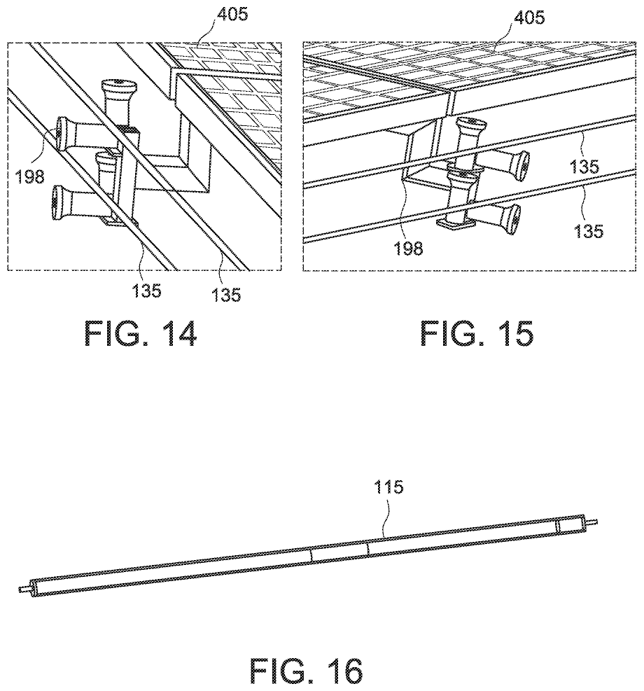

FIGS. 14 and 15 are closer views of the cable organizer 198, showing its projections that keep the forward and backward parts of the cable apart, over which they slide.

FIG. 16 illustrates a telescopic drive shaft 115 of the stationary assembly of the system in expanded and contracted modes, respectively.

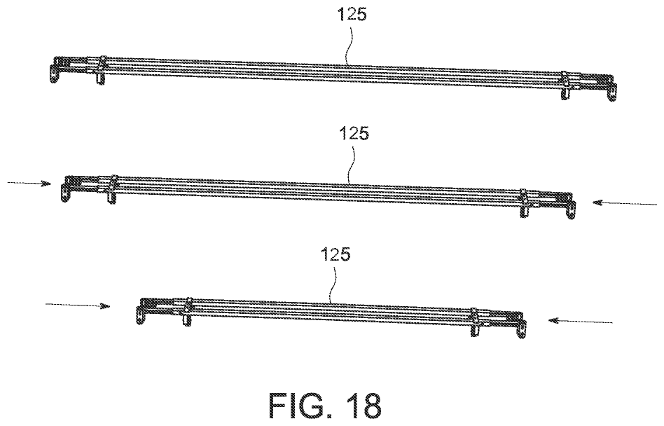

FIG. 18 illustrates another option of the telescopic cleansing rack 125 that can be adjusted to the solar panels width on both sides. The telescopic extensions of the drives shaft are shown in the three full, mid and minimal states.

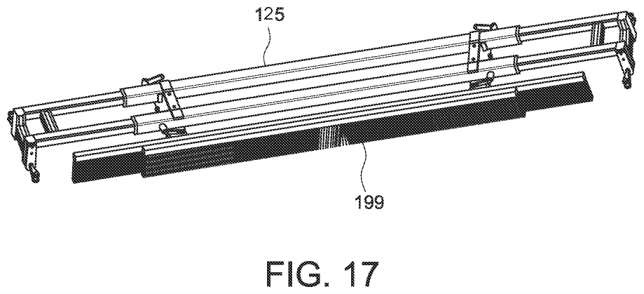

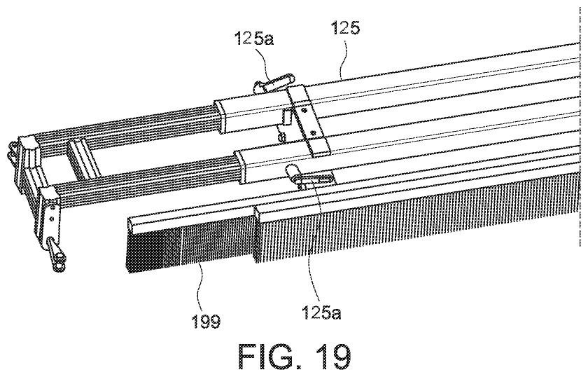

FIG. 17 illustrates an adjustable broom 199 mounted on a telescopic cleansing rack 125 that travels along the solar panels in the cleaning process. The broom 199 comprises two or more broom panels parallel each other, attached to the rack 125 and move along with it. FIG. 19 shows a closer view of the adjustable double broom 199 with rotary drive handles 125a that connect to the telescopic rack 125 and the broom 199 nearest to the rack 125. The rotation of this handle 125a extends and returns the extensions of the rack 125 and simultaneously travels the nearest broom away and towards the parallel broom behind it. This way the broom 199 extends and contracts in concert with the rack 125 and matches itself to the width of the solar panel or array of panels 405.

Several embodiments are contemplated for an extendable sprinkler pipe that can be adjusted to the length of the moving telescopic rack. One option is to provide the sprinkler pipe in a kit with the maximal length that matches the length of the rack and width of the solar panel or array of panels. Then the pipe can be cut and shortened to the proper width that is actually required when installing the cleaning system on the solar panels. A second option is to provide a sprinkler pipe with minimal length that is already attached to the rack and a kit with a pipe segment that fits the extension length of the telescopic rack to cover the full width of the solar panel array. This pipe segment can be added when installing the sprinklers and may further contain marks for making openings for installing the additional sprinklers. These openings may be ready-made for installing the sprinklers, or the pipe segment may be provided with marks for making holes onsite for installing the sprinklers.

Mega solar panel farms are deployed in arid and/or distant areas, e.g., deserts, highlands, with no or difficult access to water sources. The panels in these farms tend to be more frequently and extensively covered with dust, dirt and sand, which are lifted from the ground or carried away by strong winds. A more frequent dry, water-free cleaning of the panels' surface is, therefore, required for such mega farms. The system of the present invention is suitable for this objective by installing only dry cleaning devices such as brooms, sweepers, wipers, brushes and combs. The number of brooms, sweepers, wipers, brushes and combs may vary depending on the area conditions and cleaning requirements. Also different types of brooms, broom bristles, bristle thickness and entanglement can be adapted to meet such conditions and requirements and improve cleaning quality. The frequency of sweeping the solar panels is set to prevent accumulation of dust, sand and dirt and also prevent the creation of stain spots that are difficult to be dusted off and need to be scraped off the surface. The system of the present invention is may be used with air pressure for cleansing the surface covers of the solar panels. Accordingly the mobile assembly for cleaning the solar panels comprises jet sprinklers, which are jet air jet sprinklers configured for streaming air at high pressure over the cover surface of the solar panels for expelling accumulated solids.

### LIST OF REFERENCE NUMBERS

100—cleaning system
105—water feeding pipe
105a—hook
105b—sprinkler carrier
105c—rail
105d—rolling wheels
110—electric motor for drive shaft
115—drive shaft
120—drive wheel (pulley)
125—cleansing rack
125a—rack wheels
130—sprinklers
135—steel cable
140—start sensor
140a—termination sensor stopper
145—termination sensor
145a—termination sensor traveling stopper
145b—termination sensor stopper
150—water streaming pipe
155—water pressure pump for insufficient pressure (optional)
160—cable drum
165—pressure sprinklers
170—side wipers
180—run-off, long range, splash sprinklers
185—“bird” wipers
190—triangular cleansing rack
195—traveling, run-off, single or assembly of splash sprinklers
197—stretcher
198—cable organizer
199—broom
200—main control cabinet
205—ion exchange filter
210—water pressure pump (optional)
215—main electric controller
305—rigid pipes
310—elastic pipes
315—control valve
405—main area of solar panels
410—side (“bird”) area of solar panels

1. A system for cleaning solar panels, said system comprising:
a mobile assembly for cleaning said solar panels, said mobile assembly is movable over cover surface of said solar panels;
a stationary assembly for moving said mobile assembly, said stationary assembly is fixed relative said solar panels;
a water feeding assembly for feeding water to said mobile assembly, said water feeding assembly connects to and is in fluid communication with said mobile assembly; and
a control and command cabinet for controlling operation of said mobile assembly, stationary assembly and water feeding assembly,
wherein said stationary assembly connects mechanically to said mobile assembly and is configured to move said mobile assembly over said cover surface of said solar panels according to commands delivered from said control and command cabinet.

2. The system according to claim 1, wherein said mobile assembly comprises:
a rack mounted above said cover surface of said solar panels; and
jet sprinklers attached to nozzles in said rack;
wherein said jet sprinklers are configured to receive water from said water feeding assembly through said nozzles in said rack and spray water on cover surface of said solar panels,
wherein said jet sprinklers are adjustable to different directions including up, down, left and right relative to said cover surface of said solar panels,
wherein said solar panels are in inclined position,
wherein slide(s) at end of inclined legs of said rack are mechanically held to a steel cable and configured to slide over said steel cable,
wherein said rack travels over said surface cover of said solar panels when said steel cable roles around drive wheels.

3. The system according to claim 2, wherein said rack further comprises wheels for traveling over said cover surface of said solar panels.

4. The system according to claim 2, wherein said rack further comprises nozzles for run-off, long range, splash sprinklers for throwing water ahead of a water rake that an array of said jet sprinklers forms, said run-off, long range, splash sprinklers are configured to dissolve hard dirt or stains before arrival of said jet sprinklers.

5. The system according to claim 2, wherein said rack further comprises sweepers and wipers attached to said rack, wherein said sweepers and wipers are selected from brooms, brushes, combs and floor rags, wherein said sweepers and wipers are combined with water jet nozzles.

6. The system according to claim 5, wherein said wipers are “bird” wipers and side wipers for wiping and expelling solid or solidified dirt off of margins of said cover surface.

7. The system according to claim 5, wherein said brooms and brushes are selected from brushes and combs, wherein broom and comb bristles, bristle thickness and entanglement are selected to meet arid, desert, highland and/or distant areas with no or difficult access to water sources, wherein frequency of sweeping and cleaning said solar panels is set to prevent accumulation of dust, sand and dirt and creation of stain spots that are difficult to be dusted off and should be scraped off the surface.

8. The system according to claim 2, wherein said rack is connected to said water feeding assembly with a water feeding pipe.

9. The system according to claim 2, wherein said rack is telescopic and extendable in one or both of its ends and adjustable to match total width of said solar panels, wherein a pipe that holds said jet sprinklers is adjustable to total length of said rack and corresponding width of said solar panels.

10. The system according to claim 9, wherein said pipe is provided separately from said rack in a length corresponding to said length of said rack and total width of said solar panels or as a pipe extension that connects to an existing pipe attached to said rack, or a telescopic pipe, wherein said pipe is provided with marks for making holes for attaching said jet sprinklers onsite or ready-made holes for attaching said jet sprinklers onsite or said jet sprinklers are already attached to said separate pipe or pipe extension.

11. The system according to claim 1, wherein said stationary assembly comprises:
an electric motor;
a drive shaft;
at least one pulley comprising drive wheels at opposite ends of said at least one pulley and a steel cable stretched between and over said drive wheels;
a start sensor;
a termination sensor;
electronic cards; and
an electric circuitry,
wherein said electric motor is mounted on said drive shaft and configured to move said drive shaft in a rotational movement,
wherein said drive shaft mechanically connects to said drive wheels and transfers said rotational movement to said drive wheels, said rotational movement of said drive wheels translates to linear movement of a steel cable stretched over and between said drive wheels,
said linear movement of said steel cable makes rack of said mobile assembly travel over cover surface of said solar panels,
wherein said start and termination sensors are configured to identify start and termination positions of said mobile assembly and correspondingly initiate, terminate and reverse travel of said rack over said cover surface.

12. The system according to claim 11, comprising two pulleys, wherein one pulley is parallel elevated side of inclined position of said solar panels and a second pulley is parallel lower side opposite said elevated side of said inclined solar panels, wherein said slides at ends of inclined legs of a cleansing rack mechanically connect each to one of said two said steel cables of said pulleys, wherein said pulleys connect to said drive shaft and travel said cleansing rack over said cover surface by translating said rotational movement of said drive shaft to linear movement of said steel cables.

13. The system according to claim 11, comprising a single pulley parallel one elevated side of said solar panels in inclined position, wherein said rack is triangular with its base connected to said steel cable with slides at said base and its apex travels on a wheel parallel lower side of said solar panels.

14. The system according to claim 11, further comprising a cable organizer mounted on said steel cable of said pulleys and keeps forward and backward moving sections of said steel cable in place without getting entangled with each other, said cable organizer comprising projections over which said forward and backward moving sections of said steel cable slide and kept apart from each other.

15. The system according to claim 11, wherein said drive shaft is telescopic and connects to said electric motor at an engagement point on one end and a drive wheel on opposite end, wherein said telescopic drive shaft transfers rotational movement from said electric motor to said drive wheel and is configured to extend and contract according to width of said solar panels, wherein said electric motor controls axial movement of said drive shaft for extending and contracting according to the width of said solar panels.

16. The system according to claim 2, further comprising an extendable broom, said extendable broom comprises at least two broom panels, wherein said broom panels are parallel each other and parallel said rack, wherein said rack is telescopic, wherein one of said broom panel in front is attached to said telescopic rack with a handle that moves said broom panel parallel a second broom panel to adjust to length of extension of said telescopic rack and corresponding total width of said solar panels, thereby extending total length of said extendable broom and adjusting it to length of said telescopic rack and total width of said solar panels.

17. The system according to claim 11, further comprising cable stretchers at sides of said drive shaft, said stretchers keeping said steel cables at lower and upper sides of said solar panels tight so that said rack of said mobile assembly slides along and over the solar panels.

18. The system according to claim 11, wherein said start sensor and termination sensor comprise a micro-switch and lever, wherein said micro-switch of said termination sensor signals arrival of said mobile assembly to distal edge of said solar panels and said micro-switch of said start sensor signals arrival at a docking point of said mobile assembly at proximal edge of said solar panels when said lever of said start sensor is pressed against said mobile assembly.

19. The system according to claim 18, wherein said termination sensor is fixed at said docking point, wherein said stationary assembly further comprises a stopper ball mounted on lower part of said steel cable at destination point of arrival for said mobile assembly and configured to travel backwards with said steel cable from said destination point to said docking point, and a stopper ring, said stopper ring is fixed at said docking point and in friction communication with said lever of said termination sensor, wherein forward traveling of said mobile assembly over said solar panels makes said stopper ball travel backwards to said docking point, wherein hitting of said stopper ring of said stopper ball presses said lever of said termination sensor and signals arrival of said mobile assembly to said destination point on said solar panels.

20. The system according to claim 1, wherein said water feeding assembly is directly connected to a water feeding drum (reservoir) or a main, local or municipal water supply system.

21. The system according to claim 1, wherein said water feeding assembly further comprises a high pressure water pump and water pipe for feeding water to said mobile assembly at high pressure.

22. The system according to claim 1, wherein said stationary assembly comprises a single pulley parallel elevated side of said solar panels in inclined position, said pulley comprising drive wheels and a steel cable stretched over and between said drive wheels; and a traveling single or assembly of long range, run off, splash sprinklers attached to said steel cable with slides.

23. The system according to claim 22, further comprising a cable drum over which a water feeding pipe is rolled up.

24. The system according to claim 22, further comprising a traveling rack carrying a water feeding pipe, said traveling rack comprising hooks over which said water feeding pipe is rolled, wheels assembly traveling inside a rail, said wheels hold said hooks, and sprinkler or sprinkler assembly carrier attached to distal end of said water feeding pipe, wherein said traveling rack deploys when said mobile assembly travels forwards over said cover surface of said solar panels, wherein said water feeding pipe deploys upon forward movement of said traveling rack, wherein said water feeding pipe folds when said traveling rack folds back.

25. The system according to claim 24, comprising a start sensor, wherein said start sensor is positioned a selected distance ahead of said termination sensor, said distance is determined according to total folded length of said water feeding pipe in folded state and said destination point of said traveling, run-off, single or assembly of splash sprinklers, wherein said stopper ball is mounted on a selected location on said lower part of said steel cable, said selected location is determined according to said distance of said start sensor ahead of said termination sensor and traveling distance of said stopper ball for hitting said stopper ring.

26. The system according to claim 1, wherein said mobile assembly for cleaning said solar panels comprises jet sprinklers, said jet sprinklers are air jet sprinklers configured for streaming air at high pressure over said cover surface of said solar panels for expelling accumulated solids.

27. The system according to claim 1, wherein said control and command cabinet controls operation of a plurality of said mobile assembly, stationary assembly and water feeding assembly for cleaning a farm comprising a plurality of solar panels, said system further comprising:
a water filter and/or ion exchanger for replacing calcinated compounds with compounds that do not precipitate in water in order to prevent watermarks after washing;
a water pressure pump for controlling distribution of water between a plurality of control valves;
rigid pipes;
elastic pipes, wherein said rigid pipes connect to said elastic pipes for delivering water from said valves to said plurality of mobile assembly; and
a main electric controller that controls operation of electric motor, valves and sensors that sense start and finish of a traveling session of said mobile assembly along and said he solar panels.
